(19) United States
(12) Patent Application Publication
(10) Pub. No.: US 2008/0300321 A1
(43) Pub. Date: Dec. 4, 2008

(54) MULTICOLOR COMPONENT ADHESIVE SYSTEM

(76) Inventor: Dieter ZIMMERMANN, Langenzenn (DE)

Correspondence Address: OSTROLENK FABER GERB & SOFFEN, 1180 AVENUE OF THE AMERICAS, NEW YORK, NY, 100368403, US

(21) Appl. No.: 12/132,739

(22) Filed: Jun. 4, 2008

(30) Foreign Application Priority Data
Jun. 4, 2007 (DE) 102007026256.8-43

(51) Int. Cl. A01N 25/00; C08L 67/00; C08K 3/22; C08K 5/00; C09J 11/04; C09J 11/06

(52) U.S. Cl. 514/772.3; 524/599; 524/497; 524/431; 524/407; 524/81; 524/502; 524/589; 524/556; 524/612; 524/425; 524/430; 524/432; 524/104; 524/90; 524/174; 524/186; 524/83

(57) ABSTRACT

The present invention relates to a multicolor component adhesive system based on at least two miscible polymerizable components and a curative component, said system being suitable for providing an adhesive having any desired color. The present invention further relates to the use of the adhesive produced on the basis of the multicolor component adhesive system as an adhesive compound, jointing compound, repair material and/or filling material, preferably for plastics, more particularly cast stone, mineral substrates, more particularly natural stone, ceramic, earthenware, porcelain, metals and/or wood, and also to a method of producing the adhesive.

### CROSS REFERENCE TO RELATED APPLICATIONS

The present application claims priority of German Application No. 102007026256.8-43 filed Jun. 4, 2007.

### TECHNICAL FIELD

The present invention relates to a multicolor component adhesive system based on at least two manually miscible polymerizable components and if desired a curative component, said system being suitable for providing an adhesive, more particularly a stone adhesive, having any desired coloration. The present invention further relates to the use of the adhesive produced on the basis of the multicolor component adhesive system as an adhesive compound, jointing compound, repair material and/or filling material, preferably for plastics, more particularly cast stone, mineral substrates, more particularly natural stone, ceramic, earthenware, porcelain, metals and/or wood, and also to a method of producing the adhesive.

### BACKGROUND OF THE INVENTION

DE 295 08 712 A1 describes a structural adhesive based on cold-curing two-component polyester resins or cold-curing two-component epoxy resins, to which pigments are added for the purpose of coloration. A structural adhesive of this kind, however, has the disadvantage that a specially color-matched structural adhesive in the appropriate color must be provided for each of the different materials to be joined. Owing to the rapid solidification of the pre-colored adhesives, the mixing of the completed different-colored pre-colored adhesives is not a possibility. Furthermore, in the case of conventional adhesive systems, coloring is carried out by adding color pastes having a very high concentration of dyes, which make it difficult to provide adhesives in defined, predictable colors with low color intensity, particularly adhesives in different gradations of gray and/or of beige.

### SUMMARY OF THE INVENTION

It is an object of the present invention, therefore, to provide an adhesive system which allows the production of adhesives having a wide color spectrum, preferably over the entire color spectrum, with precisely defined and reproducible colors being obtainable.

The present object is achieved by means of a multicolor component adhesive system comprising
at least two mutually miscible polymerizable components, each of the at least two mutually miscible polymerizable components comprising one or more polymerizable compounds, and
a) at least one of the mutually miscible components comprising no coloring agent and all further mutually miscible polymerizable components each comprising at least one coloring agent, or
b) the mutually miscible polymerizable components each comprising at least one coloring agent,
the mutually miscible polymerizable components which comprise at least one coloring agent each comprising coloring agents that are different in color from one another, and the miscible polymerizable components each being present separately from one another.

### DETAILED DESCRIPTION OF CERTAIN EMBODIMENTS OF THE INVENTION

In one embodiment of the multicolor component adhesive system of the invention it preferably comprises at least three mutually miscible polymerizable components each comprising coloring agents having different colors from one another. In one embodiment of the multicolor component adhesive system of the invention it comprises preferably three to fifteen, more preferably four to ten, more preferably still five to eight, mutually miscible polymerizable components which each comprise coloring agents whose colors differ from one another. Preferably one of the mutually miscible polymerizable components comprises no coloring agent.

In one embodiment the polymerizable compounds and, where appropriate, the curative component are substantially colorless, transparent, opalescent, of a see-through champagne color and/or have a color lighter than a champagne see-through color. This facilitates the mixing of any desired colors. By see-through is preferably meant that the color is not opaque and that underlying colors remain at least partly visible.

In one embodiment the mutually miscible polymerizable components which comprise a coloring agent comprise, in each case independently of one another, a concentration of the coloring agent of 0.01% to 10% by weight, preferably 0.1% to 3% by weight, based in each case on the total weight of an individual mutually miscible polymerizable component. The low concentration of coloring agent permits the formulation of precise colors. The formulation of reproducible colors is also possible with precision in cases where the mixing of the polymerizable components is repeated. This applies more particularly to the production of light colors.

The term “in each case independently of one another” denotes preferably that the additionally added substance may be present in different concentrations in the individual components.

In one embodiment the multicolor component adhesive system further comprises a curative component which is present separately from the miscible polymerizable components.

The mixing of the different-colored miscible polymerizable components permits the provision of a polymerizable mixture preferably of any desired color. After a curative component has been added to the polymerizable mixture, the precisely color-matched adhesive undergoes curing. To facilitate the setting of the ratio in which the different-colored miscible polymerizable components and the curative are mixed, it is possible to provide mixing tables which contain details relating to the mixing ratios of the individual components.

In one preferred embodiment the mutually miscible polymerizable components and optionally the curative component comprise a thixotropic agent. Thixotropic agents in the sense of the invention are preferably substances which largely prevent the flow of the miscible polymerizable components and/or the curative component and yet ensure formability. The mutually miscible polymerizable components and/or the curative component are preferably pastelike. Preferably the thixotropic agent is selected such that, on extrusion of the miscible polymerizable components and optionally the curative component from, for example, tubes and/or cartridges, precisely defined volume amounts are obtained.

The addition of the thixotropic agents produces preferably a very soft but firm consistency, particularly for application to vertical surfaces. The addition of the thixotropic agent to the polymerizable components and optionally to the curative component produces a consistency which permits precise metering of the preferably pastelike polymerizable components and optionally the curative component.

As thixotropic agents it is possible for example to use fumed hydrophilic and/or hydrophobic silicas, hydrogenated or nonhydrogenated castor oil derivatives, optionally modified with waxes, or to use phyllosilicates and/or organically modified phyllosilicates, such as bentonites, and/or polyamides. In one embodiment the fumed hydrophilic and/or hydrophobic silicas have a BET surface area of more than 50 m²/g, more preferably of 100 m²/ to 400 m²/g. It is preferred additionally to add an OH-group-containing additive to the silicas that accelerates the formation of hydrogen bonds. The mutually miscible polymerizable components and/or the curative component preferably comprise, in each case independently of one another, 0.5% to 10% by weight, preferably 2% to 7% by weight, of thixotropic agent(s), based on the total weight of the component to which they are added in each case.

In one embodiment one or more of the mutually miscible polymerizable components and optionally the curative component comprise at least one UV stabilizer. Examples of suitable UV stabilizers include 2-(2-hydroxyphenyl)-2H-benzotriazoles, (2-hydroxyphenyl)-S-triazines, hydroxybenzophenones, oxalanilides and/or mixtures thereof. The addition of UV stabilizers makes it possible to retard and/or prevent the yellowing of the adhesive that may be produced on the basis of the multicolor component system. Preferably the mutually miscible polymerizable components and/or the curative component comprise, in each case independently of one another, 0.1% to 1.5% by weight of UV stabilizers, based on the total weight of the component to which they are added in each case.

The miscible polymerizable compounds are preferably chosen such that after polymerization they produce polymers selected from the group encompassing polyester resins, acrylic resins, polyurethane resins, epoxy resins, vinyl ester resins, epoxy acrylates and/or mixtures thereof. One preferred embodiment uses unsaturated polyester resins and/or unsaturated polyacrylic resins as polymerizable compounds. In one particularly preferred embodiment the polymerizable compounds comprise unsaturated polyester resins in solution in styrene monomers. The concentration of the polyester resins is preferably 60% to 70% by weight, based on the total weight of the dissolved unsaturated polyester resins and the styrene monomer solution.

As polymerizable compounds it is possible to use polymerizable acrylic resins based on polymers of the monomers from methyl methacrylate, ethyl methacrylate, 1,4-butanediol dimethacrylate, methacrylic acid, methacrylamide, methyl acrylate, ethyl acrylate, n-butyl acrylate, 2-hydroxyethyl acrylate, acrylic acid and/or glycidyl acrylate.

As polymerizable compounds it is possible to use unsaturated polyester resins which have been prepared by polycondensing dicarboxylic acids with diols. The dicarboxylic acids may be selected for example from the group encompassing maleic acid (anhydride), fumaric acid, itaconic acid, citraconic acid, mesaconic acid, chloromaleic acid, o-phthalic acid, isophthalic acid, terephthalic acid, tetrahydrophthalic acid, succinic acid, adipic acid, sebacic acid and/or mixtures thereof. The diols may be selected for example from the group encompassing ethylene glycol, diethylene glycol, triethylene glycol, 1,2-propylene glycol, dipropylene glycol, 1,3-butylene glycol, 1,4-butanediol, 1,6-hexanediol, neopentyl glycol, glycerol, trimethylpropane, hexane-1,2,6-triol, pentaerythritol and/or mixtures thereof. The polycondensates, for the purpose of setting the viscosity, are preferably dissolved in reactive diluents such as styrene, vinyltoluene, alpha-methylstyrene, diallyl phthalate, methacrylate, methyl methacrylate, n-butyl methacrylate, acrylonitrile and/or vinyl acetate. The polyester resins are used more particularly in the interior segment.

As polymerizable compounds it is also possible to use vinyl ester resins and/or epoxy acrylates which are preparable by condensation from acrylic and/or methacrylic acid with epoxides, based for example on bisphenol A, bisphenol F and/or novolaks.

As polymerizable compounds it is possible to use addition-crosslinking polymers, such as epoxy resin systems, for example. Use is made, by way of example, of aromatic epoxy resins, such as bisphenol A, bisphenol F and/or diglycidyl ether, and/or cycloaliphatic epoxy resins, such as vinylcyclohexene dioxide, diglycidyl hexahydrophthalate, bis(2,3-epoxycyclopentyl) ether, diglycidyl tetrahydrophthalate, and/or mixtures of these. Where appropriate they can be diluted with reactive diluents such as butyl glycidyl ether, C₁₂ to C₁₅ alkyl glycidyl ether, 4-tert-butylphenyl glycidyl ether, phenyl glycidyl ether, o-cresyl glycidyl ether, ethylene glycol diglycidyl ether, butane-1,4-diol diglycidyl ether, hexane-1,6-diol diglycidyl ether, polypropylene glycol diglycidyl ether, polybutylene glycol diglycidyl ether, neopentylene glycol diglycidyl ether, poly(tetrahydrofuran) diglycidyl ether, 1,4-cyclohexanedimethanol diglycidyl ether, glycerol triglycidyl ether, and/or 1,1,1-trimethylolpropane triglycidyl ether.

The cold curing of epoxy resin systems is accomplished, for example, by means of a curative component, such as a polyamine, for example. Examples of suitable polyamines include ethylenediamine, diethylenetriamine, triethylenetetramine, isophoronediamine, m-phenylenediamine, 4,4′-diaminodiphenylmethane, their adducts, polyaminoamides having the general formula HO—(OC—R—CO—NH—R′—NH—)ₙ—H and/or Mannich bases formed from phenol derivatives, preferably bisphenols, such as bisphenol A, for example. The epoxy resin systems are used more particularly in the exterior segment.

As polymerizable compounds it is also possible to use addition-crosslinking polymers, such as polyurethane systems, for example. As resin components it is possible to use polyols based on natural products, such as castor oil, for example, and/or synthetic polyols, such as polyester polyols and/or polyether polyols, for example. As curative components it is possible to use diisocyanates of the general formula O═C═N—R—N═C═O, such as 2,4- and/or 2,6-tolylene diisocyanate, methylenediphenyl 4,4′-diisocyanate, hexamethylene diisocyanate, naphthylene 1,5-diisocyanate, and/or isophorone diisocyanate, for example.

The curative component for the purposes of the present invention preferably comprehends substances which trigger the polymerization of the polymerizable components. As a curative component it is possible to use thermal initiators, redox initiator systems and/or photochemical free-radical generators. In the case of addition-crosslinking systems, one of the two components is termed the polymerizing component and the other component the curative component. The curative component may further comprise a plasticizer as well.

In one embodiment the curative component used, more particularly in the context of the polymerization of polyester resins and/or acrylic resins, comprises azo compounds, curatives such as azobis(isobutyronitrile), for example, and/or peroxides, more particularly diaryl peroxides, dialkyl peroxides and/or ketone peroxides, such as dibenzoyl peroxide, dilauryl peroxide, methyl ethyl ketone peroxide, acetylacetone peroxide and/or cyclohexanone peroxide, for example. A suitable redox initiator system is, for example, a mixture of iron(III) acetylacetonate, benzoin and/or benzil dimethyl ketal. In one embodiment benzoin and/or benzil dimethyl ketal are used as photochemical free-radical generators.

The weight ratio of all the polymerizable components to the curative component is preferably from 100:1 to 100:4 in the case of free-radically and/or ionically crosslinking polymers, such as polyester resins and/or acrylic resins. The curative component comprises preferably 20% to 60% by weight, more preferably 40% to 60% by weight, of a curative and 40% to 80% by weight, more preferably 40% to 60% by weight, of another substance, such as a plasticizer, for example.

In the case of addition-crosslinking polymers, such as epoxy resins and/or polyurethane resins, the weight ratio of the polymerizable component to the curative component is preferably from 1:1 to 10:1, more preferably 5:1.

The concentration of the polymerizable compounds in a polymerizable component is preferably 10% to 98% by weight, preferably 80% to 95% by weight, based on the total weight of the polymerizable component.

In one embodiment the polymerizable compounds, in addition to the polymer precursors defined above, further comprise 0.1% by weight to 90% by weight, preferably 30% to 40% by weight, of reactive diluents, based on the total weight of the polymerizable compounds. By reactive diluents in the sense of the present invention are meant, preferably, polymerizable monomers which are suitable for dissolving polymers and/or their precursors. In one embodiment there is no reactive diluent present in the polymerizable compounds.

Preferably no UV-curing polymerizable compounds and/or UV curative components are used.

In one embodiment the at least two miscible polymerizable components further comprise one or more additives selected from the group encompassing reaction accelerants, adhesion promoters, stabilizers, fillers, structure substances, drying additives, biocidal substances and/or mixtures thereof. The stabilizers may also be referred to as polymerization stabilizers.

By reaction accelerants in the sense of the invention are meant preferably substances which shorten the cure time of the adhesive at room temperature. The adhesive preferably cures within a period of 15 to 120 min, preferably of 30 to 90 min. As reaction accelerants it is possible to use aromatic amines. The aromatic amines preferably have 2 aliphatic radicals and one aromatic radical. Examples of those which have proven suitable include N,N-dimethyl-o-toluidine, N,N-bishydroxyethyl-p-toluidine and/or N,N-dimethylaniline, in monomeric and/or condensed form. As reaction accelerants it is further possible to use metal salts, examples being Co and/or vanadium salts, and/or organometallic compounds, such as Co octoates, for example.

By stabilizers in the sense of the invention are meant preferably substances which retard the polymerization of the polymerizable compounds. These stabilizers may also be referred to as polymerization stabilizers. This allows the multicolor component system of the invention to be stored for a longer time.

As stabilizer or polymerization stabilizers it is possible to use phenols and/or quinones. As stabilizers it is possible for example to use hydroquinone, toluhydroquinone, pyrocatechol, tert-butylhydroquinone, 4-tert-butylpyrocatechol, hydroquinone monomethyl ether, p-benzoquinone, naphthoquinone, 2,5-di-tert-butylhydroquinone, 3,5-di-tert-butylpyrocatechol, chloroaniline and/or mixtures thereof.

By drying additives in the sense of the invention are meant preferably substances which accelerate the drying rate of the adhesive. This is achieved by these drying additives more particularly accelerating the polymerization at the surface of the adhesive. As drying additives it is possible for example to use paraffins, synthetic derivatives thereof, and/or siccatives, such as Co octoate. The mutually miscible polymerizable components and/or the curative component preferably comprise, in each case independently of one another, 0.1% to 1.5% by weight of drying additives, based on the total weight of the component to which they are added in each case.

By adhesion promoters in the sense of the present invention are meant preferably substances which improve the adhesion of the adhesive that can be produced from the multicolor component adhesive system to the substrates that are to be joined. In one embodiment of the multicolor component adhesive system of the invention the polymerizable components comprise, in each case independently of one another, 0.1% to 5% by weight, preferably 0.5% by weight to 2.5% by weight, of adhesion promoter(s), based on the total weight of in each case the individual polymerizable component to which they are added in each case. Alternatively the multicolor component system of the invention may also comprise an additional adhesion promoter component which is present separately from the at least two polymerizable components and from the curative component. In that case the adhesion promoter component is applied directly to the substrates that are to be bonded, prior to bonding. As adhesion promoters it is preferred to use organosilanes.

One embodiment of the multicolor component adhesive system of the invention uses methacryloyloxysilanes, vinylsilanes, epoxysilanes, aminosilanes and/or isocyanatosilanes as adhesion promoters.

For the individual systems of the polymerizable compounds the following adhesion promoters are suitable with preference:

a) One embodiment uses unsaturated polyester resins, acrylate resins, vinyl ester resins and/or epoxy acrylates as polymerizable compounds in combination with adhesion promoters, such as methacryloyloxysilanes and/or vinylsilanes. By way of example it is possible as adhesion promoters to use vinyltriethoxysilane, vinyltris(2-methoxyethoxy)silane, vinyltrimethoxysilane, vinylmethyldimethoxysilane, vinyltriacetoxysilane, (3-methacryloyloxypropyl)trimethoxysilane, (methacryloyloxymethyl)methyldimethoxysilane, (methacryloyloxymethyl)trimethoxysilane and/or (methacryloyloxymethyl)methyldiethoxysilane.

b) One embodiment uses epoxy resin systems as polymerizable compounds in combination with adhesion promoters, such as epoxysilanes. By way of example it is possible to use beta-(3,4-epoxycyclohexyl)ethyltrimethoxysilane, gamma-glycidyloxypropyltrimethoxysilane, (3-glycidyloxypropyl)trimethoxysilane and/or (3-glycidyloxypropyl)triethoxysilane as adhesion promoters.

One embodiment uses amine curatives in combination with aminosilanes as adhesion promoters. By way of example it is possible to use N-(2-aminoethyl)(3-aminopropyl)trimethoxysilane, (3-aminopropyl)trimethoxysilane, N-(2-aminoethyl)(3-aminopropyl)methyldimethoxysilane and/or (3-aminopropyl)triethoxysilane as adhesion promoters.

c) One embodiment uses, in the case of polyurethane systems, the polyol components in conjunction with aminosilanes as adhesion promoters. By way of example it is possible to use N-(2-aminoethyl)(3-aminopropyl)trimethoxysilane, (3-aminopropyl)trimethoxysilane, N-(2-aminoethyl)(3-aminopropyl)methyldimethoxysilane and/or (3-aminopropyl)triethoxysilane as adhesion promoters.

One embodiment uses, in the case of polyurethane systems, the isocyanate components in conjunction with isocyanatosilanes as adhesion promoters. By way of example it is possible to use (isocyanatomethyl)methyldimethoxysilane and/or (isocyanatomethyl)trimethoxysilane as adhesion promoters.

In a further embodiment of the invention the fillers and/or structure substances are selected from the group encompassing carbonates, more particularly calcium carbonate and/or magnesium carbonate, talc, clays, kieselguhr, siliceous earth, calcite, dolomite, finely ground quartz, aluminum oxide, aluminum hydroxide, kaolin, mica, pearlescent pigments, metallic effect pigments, calcium sulfate, barium sulfate, glass fibers, glass beads, wood flour, cellulose powder and/or mixtures thereof. By structure substances in the sense of the invention are meant substances and/or compounds which permit the adhesive to be matched visually to the visible structures of the articles to be joined, more particularly the cast stones or natural stones to be joined. With the multicolor component system of the invention it is possible to produce color-matched adhesives which are suitable more particularly for joining natural mineral substrates and/or artificial substrates having a mineral appearance.

The particle size of the fillers is situated preferably in a range from 0.1 to 200 μm, more preferably from 1 to 50 μm.

The particle size of the structure substances is situated preferably in a range from 100 to 1000 μm, more preferably from 250 to 900 μm. In one embodiment the structure substances are in platelet form. The ratio of length to width of the platelets is preferably 1:4 to 1:8.

The miscible polymerizable components preferably comprise, in each case independently of one another, 1% to 70% by weight, more preferably 10% to 65% by weight, of structure substances and/or fillers, based on the total weight of the miscible polymerizable component to which they are added in each case.

By biocidal substances are meant, preferably, substances which kill and/or prevent the growth of microorganisms, more particularly of bacteria, single-celled organisms and/or viruses. Biocidal substances which can be used include, for example, Zn-containing, Ag-containing, Sn-containing compounds and/or 2,4,4′-trichloro-2′-hydroxydiphenyl ether, benzalkonium chloride and/or mixtures thereof. The biocidal substances produce a considerable hygiene effect. The mutually miscible polymerizable components and/or the curative component preferably comprise, in each case independently of one another, 0.1% to 1.5% by weight of biocidal substances, based on the total weight of the component to which they are added in each case.

In one embodiment the mutually miscible polymerizable components have colors selected from the group encompassing colorless, transparent, opalescent, see-through champagne, white, black, yellow, green, red, blue, brown, gray, beige and/or mixtures thereof.

As coloring agents it is possible to use inorganic colorants, more particularly mineral colorants, and/or organic colorants. In one embodiment the mutually miscible polymerizable components comprise, in each case independently of one another, 0.01% to 10% by weight, preferably 0.1% to 3% by weight, of coloring agents, based on the total weight of the miscible polymerizable component to which they are added in each case. The miscible polymerizable components comprise the coloring agents preferably in homogeneous distribution.

The inorganic colorants may be selected for example from the group encompassing chalk, titanium dioxide, iron oxide, chromium oxide, cobalt oxide, carbon black, ocher, green earth, chrome yellow, red lead, ultra-marine, umber, graphite, bismuth vanadate, zinc oxide, lithopones, metallic effect pigments, pearlescent pigments, and/or mixtures thereof.

As organic colorants it is possible to use organic pigments and/or organic dyes.

In one embodiment of the multicomponent adhesive system of the invention the organic pigments are selected from the group encompassing azo dye pigments, anthraquinone pigments, quinophthalone pigments, isoindoline pigments, naphthalenetetracarboxylic acid pigments, indigoids, dioxazine pigments, quinacridone pigments, phthalocyanine pigments, isoindolinone pigments, perylene pigments, perinone pigments, organic metal complex pigments, alkali blue pigments, diketopyrrolopyrrole pigments and/or mixtures thereof.

In one embodiment of the multicomponent adhesive system of the invention the organic dyes are selected from the group encompassing azo dyes, azine dyes, anthraquinone dyes, acridine dyes, alkaloid dyes, cyanine dyes, phenoxazine dyes, polymethine dyes, thiazine dyes, triarylmethane dyes, aniline blue, aniline black, anthracene blue, Bismarck brown, 2,4-diaminoazobenzene, Ciba blue, fuchsine, Hydron blue, Immedial black, Congo red, crystal violet, malachite green, methylene blue, methyl orange, methyl violet, Variamin blue, Victoria blue dyes and/or mixtures thereof.

The colorants can be used in a dissolved or particulate form. In one embodiment the coloring agents have a particle size in a range from 10 nm to 100 μm, preferably 0.1 to 10 μm.

In one particularly preferred embodiment the at least two miscible polymerizable components, the curative component and/or adhesion promoter component are present in each case in separate stock units, such as in cartridges, tubes and/or cans, for example. The units in question are preferably diffusion-tight tubes which have been coated, for example, with aluminum. The stock units preferably have openings for the extrusion of the miscible polymerizable components and/or the curative component, which on extrusion produce strands having constant diameters. The openings of the tubes and/or the cartridges are therefore preferably designed such that it is possible to obtain a reproducible volume amount of the at least two miscible polymerizable components and/or the curative component by extruding a strand having a defined length. By this means it is possible to obtain any desired coloring with repeat precision.

In one embodiment the multicolor component adhesive system further comprises a metering aid for measuring out the at least two miscible polymerizable components, the curative component and/or the adhesion promoter component.

In one embodiment the multicolor component adhesive system comprises as a metering aid a graduated planimetric board, a graduated planimetric film, a graduated paper, a graduated tube, a graduated cartridge, a volumetric cup and/or a volumetric cylinder.

The multicolor component adhesive system of the invention can be used, for example, for producing an adhesive as an adhesive compound, jointing compound, repair material and/or filling material for mineral substrates, such as natural stone, cast stone, ceramic, earthenware, porcelain, metals and/or wood, for example. The use of polymerizable miscible components to which colorant has been added, and which may optionally further comprise structure substances, permits optimum visual matching of the adhesive to virtually any desired cast stone, natural stone, ceramic, earthenware, porcelain and/or wood.

The cast stone and/or natural stone are preferably kitchen worktops and/or windowsills.

The adhesive can be used, furthermore, to repair and/or fill the surface, more particularly that of natural stone. After curing, the adhesive preferably can be abraded and polished.

The multicolor component adhesive system of the invention permits the production of an adhesive having adhesion and/or adhesive properties. The adhesive having adhesion and/or adhesive properties is able preferably to join assembled parts to one another reliably by surface adhesion. The adhesive is preferably water-resistant. In one embodiment the adhesive is resistant up to temperatures of below 100° C., preferably below 150° C., most preferably below 250° C., and/or resistant to alkalis and/or acids.

The flexural strength of the adhesive obtained after mixing of the polymerizable components and the curative component, and color-matched, is situated preferably in a range from 100 to 110 N/mm². The flexural strength can be determined in accordance with the DIN standard 53452.

The tensile strength of the adhesive obtained after mixing of the polymerizable components and the curative component, and color-matched, is situated preferably in a range from 40 to 50 N/mm². The tensile strength can be determined in accordance with the DIN standard 53455.

One embodiment of the multicolor component adhesive system of the invention comprises:
a) a transparent polymerizable component comprising
85% to 98% by weight polymerizable compounds
2% to 10% by weight thixotropic agent(s)
0.1% to 1.5% by weight UV stabilizer
0.1% to 1.5% by weight biocidal substances
0.1% to 1.5% by weight drying additive, and/or
b) one or more colored polymerizable components without fillers or structure substances, comprising
85% to 95% by weight polymerizable compounds
2% to 10% by weight thixotropic agent(s)
0.1% to 10% by weight coloring agents
0.1% to 1.5% by weight UW stabilizer
0.1% to 1.5% by weight biocidal substances
0.1% to 1.5% by weight drying additive, and/or
c) one or more colored polymerizable components with fillers and structure substances, comprising
10% to 85% by weight polymerizable compounds
0.5% to 5% by weight thixotropic agent(s)
0.1% to 10% by weight coloring agents
0.1% to 1.5% by weight UV stabilizer
0.1% to 1.5% by weight biocidal substances
1% to 70% by weight fillers and structure substances
0.1% to 1.5% by weight drying additive, and/or
d) a curative component comprising
20% to 60% by weight organic peroxide
40% to 80% by weight plasticizer(s),
   the polymerizable compounds preferably having a reactive diluent content of 30% to 40% by weight, based on the total weight of the polymerizable compounds.

The method of producing a color-matched adhesive comprises the following steps:
a) providing a multicolor component adhesive system according to any one of claims 1 to 14,
b) mixing at least two miscible polymerizable components of the multicolor component adhesive system to a desired coloration, and
c) admixing at least a curative component.

In one embodiment of the method of the invention the desired coloration is obtained in step b) by providing in step b) a defined amount of at least 2 of the miscible polymerizable components, preferably in the form of a strand having a constant diameter and a defined length, and thereafter mixing them with one another. The mixtures obtained are subsequently, preferably, likewise mixed with a defined amount of the curative component. The defined amounts of polymerizable components and/or of the curative component are preferably measured out with the metering aid described above.

For example it is possible to obtain the defined amount of at least 2 of the miscible polymerizable components and/or the curative component by extruding the strands from a cartridge and/or tube, preferably onto a planimetric board and/or planimetric film. One embodiment uses graduated cartridges and/or tubes as a metering aid. The length of the strand can be determined by the graduation. By measuring out the strands using a graduated metering aid it is possible to determine precisely the amount of the individual miscible, polymerizable components. This permits the reproducible provision of precisely colored adhesives in any desired shade.

In one embodiment the diameter of the openings of the tubes and/or of the cartridges is 7 to 10 mm for the polymerizable components and 2 to 5 mm for the curative component, if a polymerization initiator is used as a curative component for a free-radical or ionic polymerization. In the case of the preparation of addition polymers, the diameter of the openings of the tubes and/or of the cartridges is preferably 7 to 10 mm for the polymerizable components and preferably likewise 7 to 10 mm for the curative component.

The at least two miscible polymerizable components and/or the curative component can be mixed preferably by knifing and/or stirring without the use of further tools.

The adhesive which can be produced with the multicolor component adhesive system of the invention preferably permits the reproducible production of any desired color and is distinguished additionally by good processing properties, rapid curing in the range from 30 to 90 min, high polishability, high adhesion even at elevated temperatures and/or resistance to water, gasoline and/or mineral oils.

The figure and examples below serve merely to illustrate the invention, but do not limit the scope of protection of the invention.

### BRIEF DESCRIPTION OF THE FIGURE

FIG. 1 shows a metering aid in the form of a graduated planimetric board for determining a defined amount of the miscible polymerizable components and/or of the curative component.

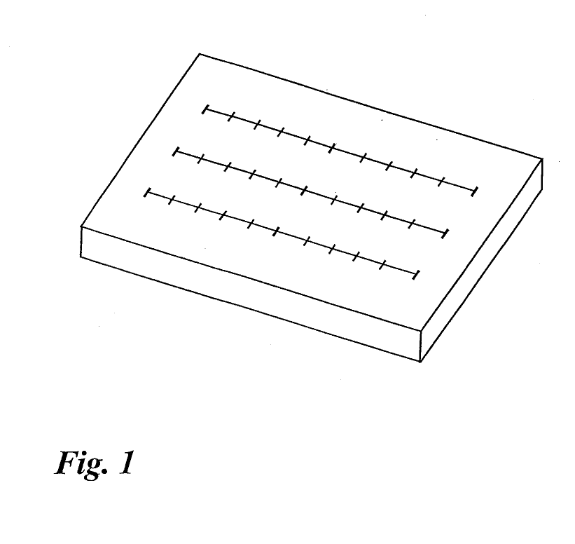

### EXAMPLE

The example below is intended to elucidate the invention in more detail but not to limit it in any way.

Preparation of the transparent miscible polymerizable component:

400 g of unsaturated polyester resin in solution in styrene is mixed with 22 g of thixotropic agent, 2 g of UV stabilizer, 1.3 g of 2,4,4′-trichloro-2′-hydroxy-phenyl ether and 1 g of paraffin and the mixture is dispersed in a high-performance stirrer mechanism, and subsequently evacuation is carried out.

Preparation of the colored miscible polymerizable components:

395 g of unsaturated polyester resin in solution in styrene is mixed with 22 g of thixotropic agent, 2 g of UV stabilizer, 1.3 g of 2,4,4′-trichloro-2′-hydroxy-phenyl ether, x g of coloring agent and 1 g of paraffin and the mixture is dispersed in a high-performance stirrer mechanism and subsequently evacuation is carried out.

The different colored miscible polymerizable components are obtained by adding different coloring agents. A number of examples are given below.

Curative component:

50% by weight dibenzoyl peroxide (BPO) in plasticizer

Formulation:

The miscible polymerizable components and the curative component are filled into diffusion-tight tubes with an aluminum coating. The tubes for the miscible polymerizable components have a tube opening of 7.8 mm. The tube for the curative component has a tube opening of 4.1 mm.

The tables below contain formulas for different colors of the miscible polymerizable components. As thixotropic agents and UV stabilizers it is possible to use the substances described above.

Mixer Color, Transparent

| | | |
|---|---|---|
| unsaturated polyester resin in solution in | 390 | g |
| styrene (65% by weight polyester resin based on | | |
| the total weight of the polyester resin | | |
| solution) | | |
| thixotropic agent | 22 | g |
| UV stabilizer | 2.15 | g |
| 2,4,4′-trichloro-2′-hydroxydiphenyl ether | 1.3 | g |
| paraffin | 1 | g |

Mixer Color, White

| | | |
|---|---|---|
| unsaturated polyester resin in solution in | 390 | g |
| styrene (65% by weight polyester resin based on | | |
| the total weight of the polyester resin | | |
| solution) | | |
| thixotropic agent | 22 | g |
| UV stabilizer | 2.15 | g |
| 2,4,4′-trichloro-2′-hydroxydiphenyl ether | 1.3 | g |
| titanium dioxide | 11.4 | g |
| paraffin | 1 | g |

Mixer Color, Black

| | | |
|---|---|---|
| unsaturated polyester resin in solution in | 390 | g |
| styrene (65% by weight polyester resin based on | | |
| the total weight of the polyester resin | | |
| solution) | | |
| thixotropic agent | 22 | g |
| UV stabilizer | 2.15 | g |
| 2,4,4′-trichloro-2′-hydroxydiphenyl ether | 1.3 | g |
| black iron oxide | 2.28 | g |
| paraffin | 1 | g |

Mixer Color, Yellow

| | | |
|---|---|---|
| unsaturated polyester resin in solution in | 390 | g |
| styrene (65% by weight polyester resin based on | | |
| the total weight of the polyester resin | | |
| solution) | | |
| thixotropic agent | 22 | g |
| UV stabilizer | 2.15 | g |
| 2,4,4′-trichloro-2′-hydroxydiphenyl ether | 1.3 | g |
| yellow iron oxide | 1.47 | g |
| paraffin | 1 | g |

Mixer Color, Brown

| | | |
|---|---|---|
| unsaturated polyester resin in solution in | 390 | g |
| styrene (65% by weight polyester resin based on | | |
| the total weight of the polyester resin | | |
| solution) | | |
| thixotropic agent | 22 | g |
| UV stabilizer | 2.15 | g |
| 2,4,4′-trichloro-2′-hydroxydiphenyl ether | 1.3 | g |
| brown iron oxide | 1.96 | g |
| paraffin | 1 | g |

Mixer Color, Red

| | | |
|---|---|---|
| unsaturated polyester resin in solution in | 390 | g |
| styrene (65% by weight polyester resin based on | | |
| the total weight of the polyester resin | | |
| solution) | | |
| thixotropic agent | 22 | g |
| UV stabilizer | 2.15 | g |
| 2,4,4′-trichloro-2′-hydroxydiphenyl ether | 1.3 | g |
| pigment red | 0.49 | g |
| paraffin | 1 | g |

Mixer Color, Green

| | | |
|---|---|---|
| unsaturated polyester resin in solution in | 390 | g |
| styrene (65% by weight polyester resin based on | | |
| the total weight of the polyester resin | | |
| solution) | | |
| thixotropic agent | 22 | g |
| UV stabilizer | 2.15 | g |
| 2,4,4′-trichloro-2′-hydroxydiphenyl ether | 1.3 | g |
| chromium oxide green | 2.28 | g |
| paraffin | 1 | g |

Mixer Color, Blue

| | | |
|---|---|---|
| unsaturated polyester resin in solution in | 390 | g |
| styrene (65% by weight polyester resin based on | | |
| the total weight of the polyester resin | | |
| solution) | | |
| thixotropic agent | 22 | g |
| UV stabilizer | 2.15 | g |
| 2,4,4′-trichloro-2′-hydroxydiphenyl ether | 1.3 | g |
| ultramarine blue | 2.13 | g |
| paraffin | 1 | g |

Mixer Color, Olive Brown

| | | |
|---|---|---|
| unsaturated polyester resin in solution in | 390 | g |
| styrene (65% by weight polyester resin based on | | |
| the total weight of the polyester resin | | |
| solution) | | |
| thixotropic agent | 22 | g |
| UV stabilizer | 2.15 | g |
| 2,4,4′-trichloro-2′-hydroxydiphenyl ether | 1.3 | g |
| titanium dioxide | 3.185 | g |
| black iron oxide | 0.69 | g |
| yellow iron oxide | 0.275 | g |
| brown iron oxide | 0.5 | g |
| chromium oxide green | 0.215 | g |
| paraffin | 1 | g |

Mixer Color, Antique White

| | | |
|---|---|---|
| unsaturated polyester resin in solution in | 380 | g |
| styrene (65% by weight polyester resin based on | | |
| the total weight of the polyester resin | | |
| solution) | | |
| thixotropic agent | 22 | g |
| UV stabilizer | 2.15 | g |
| 2,4,4′-trichloro-2′-hydroxydiphenyl ether | 1.3 | g |
| titanium dioxide | 10.875 | g |
| black iron oxide | 0.032 | g |
| paraffin | 1 | g |

Mixer Color, Brown-Beige

| | | |
|---|---|---|
| unsaturated polyester resin in solution in | 390 | g |
| styrene (65% by weight polyester resin based on | | |
| the total weight of the polyester resin | | |
| solution) | | |
| thixotropic agent | 22 | g |
| UV stabilizer | 2.15 | g |
| 2,4,4′-trichloro-2′-hydroxydiphenyl ether | 1.3 | g |
| titanium dioxide | 1.725 | g |
| yellow iron oxide | 0.18 | g |
| brown iron oxide | 0.155 | g |
| chromium oxide green | 0.055 | g |
| ultramarine blue | 0.045 | g |
| paraffin | 1 | g |

Mixer Color, Dark Gray

| | | |
|---|---|---|
| unsaturated polyester resin in solution in | 390 | g |
| styrene (65% by weight polyester resin based on | | |
| the total weight of the polyester resin | | |
| solution) | | |
| thixotropic agent | 22 | g |
| UV stabilizer | 2.15 | g |
| 2,4,4′-trichloro-2′-hydroxydiphenyl ether | 1.3 | g |
| titanium dioxide | 4.455 | g |
| black iron oxide | 0.91 | g |
| paraffin | 1 | g |

Mixer Color, Pale Gray

| | | |
|---|---|---|
| unsaturated polyester resin in solution in | 390 | g |
| styrene (65% by weight polyester resin based on | | |
| the total weight of the polyester resin | | |
| solution) | | |
| thixotropic agent | 22 | g |
| UV stabilizer | 2.15 | g |
| 2,4,4′-trichloro-2′-hydroxydiphenyl ether | 1.3 | g |
| titanium dioxide | 4.455 | g |
| black iron oxide | 0.265 | g |
| paraffin | 1 | g |

Mixer Color, Pale Beige

| | | |
|---|---|---|
| unsaturated polyester resin in solution in | 390 | g |
| styrene (65% by weight polyester resin based on | | |
| the total weight of the polyester resin | | |
| solution) | | |
| thixotropic agent | 22 | g |
| UV stabilizer | 2.15 | g |
| 2,4,4′-trichloro-2′-hydroxydiphenyl ether | 1.3 | g |
| titanium dioxide | 8.765 | g |
| yellow iron oxide | 0.065 | g |
| brown iron oxide | 0.075 | g |
| chromium oxide green | 0.037 | g |
| paraffin | 1 | g |

Mixer Color, Dark Beige

| | | |
|---|---|---|
| unsaturated polyester resin in solution in | 390 | g |
| styrene (65% by weight polyester resin based on | | |
| the total weight of the polyester resin | | |
| solution) | | |
| thixotropic agent | 22 | g |
| UV stabilizer | 2.15 | g |
| 2,4,4′-trichloro-2′-hydroxydiphenyl ether | 1.3 | g |
| titanium dioxide | 8.76 | g |
| black iron oxide | 0.088 | g |
| yellow iron oxide | 0.093 | g |
| brown iron oxide | 0.107 | g |
| chromium oxide green | 0.055 | g |
| paraffin | 1 | g |

Mixing examples for matched color mixtures for ZODIAQ® quartz surfaces worktops from DuPont®:

To produce a color-matched adhesive for different worktops, strands with the lengths indicated below are pressed from the tubes.

| | | |
|---|---|---|
| a) | Caroli Red | |
| | red mixer color | 15 cm |
| | blue mixer color | 2 cm |
| | black mixer color | 1 cm |
| | 50% BPO curative paste | 1.8 cm |
| b) | Vela Brown | |
| | transparent | 25 cm |
| | brown mixer color | 2 cm |
| | black mixer color | 1 cm |
| | 50% BPO curative paste | 2.8 cm |
| c) | Eclipse Blue | |
| | transparent | 14 cm |
| | blue mixer color | 12 cm |
| | black mixer color | 8 cm |
| | 50% BPO curative paste | 3.4 cm |

First of all color strands corresponding to the figures above are extruded from the tubes containing the different-colored polymerizable components. The length of the strands is determined by extrusion onto a graduated planimetric board. The polymerizable components are mixed. This gives a mixture of the polymerizable components that has a precisely defined color. From the tube containing the curative component, a strand is likewise extruded onto the graduated planimetric board in accordance with the figures above. The mixture of the polymerizable components is mixed with the curative component.

The mixture remains usable for 7 to 16 minutes and cures after approximately 30 to 90 minutes at 20° C.

The mechanical properties obtained by the cured adhesive are as follows:

| | |
|---|---|
| flexural strength: | 100 to 110 n/mm² |
| tensile strength: | 40 to 50 N/mm² |

1. Multicolor component adhesive system comprising
at least two mutually miscible polymerizable components,
each of the at least two mutually miscible polymerizable components comprising one or more polymerizable compounds, and
a) one of the mutually miscible components comprising no coloring agent and all further mutually miscible polymerizable components each comprising at least one coloring agent, or
b) the mutually miscible polymerizable components each comprising at least one coloring agent, the mutually miscible polymerizable components which comprise at least one coloring agent each comprising coloring agents that are different in color from one another, and the miscible polymerizable components each being present separately from one another.

2. Multicolor component adhesive system according to claim 1, further comprising a curative component which is present separately from the miscible polymerizable components.

3. Multicolor component adhesive system according to claim 2, each of the at least two mutually miscible polymerizable components and optionally the curative component comprising at least one thixotropic agent.

4. Multicolor component adhesive system according to claim 2, the polymerizable compounds and the curative component being at least one of substantially colorless, transparent, opalescent, of a see-through champagne color and having a color lighter than a champagne see-through color.

5. Multicolor component adhesive system according to claim 2, at least one of the mutually miscible polymerizable components and the curative component comprising at least one UV stabilizer.

6. Multicolor component adhesive system according to claim 2, at least one of the mutually miscible polymerizable components and the curative component comprising at least one biocidal agent.

7. Multicolor component adhesive system according to claim 1, the polymerizable compounds after polymerization producing at least one polymer which is selected from the group consisting of polyester resins, acrylic resins, polyurethane resins, epoxy resins, vinyl ester resins, epoxy acrylates and mixtures thereof.

8. Multicolor component adhesive system according to claim 1, wherein the coloring agents are at least one of inorganic and organic colorants.

9. Multicolor component adhesive system according to claim 8, the inorganic colorants being at least one selected from the group consisting of chalk, titanium dioxide, iron oxide, chromium oxide, cobalt oxide, carbon black, ocher, green earth, chrome yellow, red lead, ultramarine, umber, graphite, bismuth vanadate, zinc oxide, lithopones, metallic effect pigments, pearlescent pigments and mixtures thereof.

10. Multicolor component adhesive system according to claim 8, the organic colorants being at least one selected from the group of organic pigments consisting of azo dye pigments, anthraquinone pigments, quinophthalone pigments, isoindoline pigments, naphthalenetetracarboxylic acid pigments, indigoids, dioxazine pigments, quinacridone pigments, phthalocyanine pigments, isoindolinone pigments, perylene pigments, perinone pigments, organic metal complex pigments, alkali blue pigments, diketopyrrolopyrrole pigments and mixtures thereof.

11. Multicolor component adhesive system according to claim 8, the organic colorants being at least one selected from the group of organic dyes consisting of azo dyes, azine dyes, anthraquinone dyes, acridine dyes, alkaloid dyes, cyanine dyes, phenoxazine dyes, polymethine dyes, thiazine dyes, triarylmethane dyes, aniline blue, aniline black, anthracene blue, Bismarck brown, 2,4-diaminoazobenzene, Ciba blue, fuchsine, Hydron blue, Immedial black, Congo red, crystal violet, malachite green, methylene blue, methyl orange, methyl violet, Variamin blue, Victoria blue dyes and mixtures thereof.

12. Multicolor component adhesive system according to claim 2, at least one of the miscible polymerizable components and the curative components each being present separately from one another in stock units.

13. Multicolor component adhesive system according to claim 2, further comprising a metering aid for measuring out at least one of the at least two miscible polymerizable components and the curative component.

14. Multicolor component adhesive system according to claim 13, the metering aid being at least one of a graduated planimetric board, a graduated planimetric film, a planimetric graduated paper, a graduated tube, a graduated cartridge, a volumetric cup and a volumetric cylinder.

15. (canceled)

16. (canceled)

17. Method of producing a color-matched adhesive, comprising the following steps:
a. providing a multicolor component adhesive system according to claim 1,
b. mixing at least two miscible polymerizable components to a desired coloration, and
c. admixing a curative component.

18. Method according to claim 17, wherein the desired coloration is obtained by first providing in step b) in each case a defined amount of the different miscible polymerizable components, and thereafter mixing said components with one another.

19. Method according to claim 17, wherein step c) comprises first providing a defined amount of the curative component, and thereafter mixing it with the mixture of the polymerizable components from step b).

20. Multicolor component adhesive system according to claim 12, wherein the stock units are at least one selected from the group consisting of cartridges, tubes and cans.

21. Method according to claim 18, further comprising providing the different miscible polymerizable components in the form of a strand having a constant diameter and a defined length.

22. Method according to claim 22 wherein the length of said strand is measured by a graduated metering aid.

23. Method according to claim 19, further comprising providing the curative component in the form of a strand having a constant diameter and a defined length.

24. Method according to claim 23 wherein the length of said strand is measured by a graduated metering aid.

25. A method for providing at least one of a material selected from the group consisting of an adhesive compound, a joining compound, a repair material or filing material for plastics, a natural stone, a ceramic, earthenware, porcelain, metals and wood, which method comprises the steps of:
a. providing a multicolor component adhesive system according to claim 1;
b. mixing at least two miscible polymerizable components to a desired coloration; and
c. admixing a curative component.

26. Method of claim 25 wherein the multicolor component adhesive system is used for joining at least one of natural mineral substrates and artificial substrates having a mineral appearance.
